(19) United States
(12) Patent Application Publication
(10) Pub. No.: US 2026/0118023 A1
(43) Pub. Date: Apr. 30, 2026

(54) WORK RECOVERY IN A SHAPE MEMORY ALLOY HEAT PUMP

(71) Applicant: EXERGYN LIMITED, Dublin (IE)

(72) Inventor: Greg PITTAM, Dublin (IE)

(21) Appl. No.: 19/118,567

(22) PCT Filed: Oct. 9, 2023
(86) PCT No.: PCT/EP2023/077941

§ 371 Date: Apr. 4, 2025

(30) Foreign Application Priority Data
Oct. 7, 2022 (GB) 2214760.7

(51) Int. Cl. F25B 23/00; F03G 3/08; F03G 7/06

(52) U.S. Cl. CPC F25B 23/00; F03G 3/08; F03G 7/0614

(57) ABSTRACT

Shape-Memory Alloy heat pump system (20) and method comprising a first Shape-Memory Alloy core (21) and a second Shape-Memory Alloy core (22). A power converter (23) is connected to the first Shape-Memory Alloy core and the second Shape-Memory Alloy core and a flywheel device (24) is configured to recover and store energy from an unloading first Shape-Memory Alloy core via the power converter and provide the stored energy back to a loading second Shape-Memory Alloy core via the power converter.

### FIELD

The present disclosure relates to a Shape Memory Alloy (SMA) heat pump. In particular the disclosure relates to work recovery in a solid state SMA heat pump.

### BACKGROUND

Recent research into the Elastocaloric [EC] effect has demonstrated its potential as a solid-state alternative to traditional Vapour Compression refrigeration and/or heat pumping approaches. The EC cycle takes advantage of the superelastic behaviour of Shape Memory Alloys, which facilitates, through cyclic uniaxial loading and unloading, the absorption of heat from a low temperature source and its rejection to a higher temperature sink.

Heat Pump (“HP”) technologies have gained wide commercial acceptance in Heating Ventilation, Air Conditioning and Refrigeration (“HVAC-R”) applications. They can offer energy savings and emission reductions and are typically installed for heating and cooling systems in buildings, vehicles and electronic appliances, for example.

Heat pumps using SMA material in the form of SMA cores are known in the art. An example SMA heat pump is disclosed in PCT patent publication number WO2021/219667, assigned to Exergyn Ltd. SMAs are alloys that preserve a shape deformed by an external force below a critical temperature, whereas a shape memory effect of the alloy is activated for recovering a trained original shape by a shape recovering force after being heated to the critical temperature. SMAs such as a titanium-nickel alloy are fabricated at a high temperature to have a predetermined shape.

The efficiency of a heat pump is determined by it's COP or EER, where COP is heat out divided by work input and EER is cooling divided by work input. Thus, the net work input needs to be reduced to increase the performance of the heat pump.

Due to the cyclic nature of changing states in an SMA based heat pump system it is desirable to make the system as energy efficient as possible. Recovering the work done in uniaxial cyclic loading is an essential energy efficiency aspect of an SMA heat pump having two or more SMA cores. This cannot be easily achieved by connecting SMA cores in the high energy state part of their cycle with cores in the low energy state, because an equilibrium would be established through which some or part of the work done would be lost. In addition, it is technically very challenging to mechanically load the cores and put the energy storage on the core itself as a mass. This approach is flawed as it requires hundreds of tons of mass and huge forces beyond the capability of direct mechanical loading.

There is therefore a need for an SMA heat pump which has improved work recovery in a multi-SMA core heat pump with minimum energy loss, and this forms an objective of the present invention.

### SUMMARY

The present invention relates to an SMA based heat pump system and method of operating an SMA heat pump, as set out in the appended claims.

In one embodiment of the invention there is provided a Shape-Memory Alloy heat pump system comprising:
a first Shape-Memory Alloy core;
a second Shape-Memory Alloy core;
a power converter connected to the first Shape-Memory Alloy core and the second Shape-Memory Alloy core; and
a flywheel device configured to recover and store energy from an unloading first Shape-Memory Alloy core via the power converter and provide the stored energy back to a loading second Shape-Memory Alloy core via the power converter.

The invention makes use of a power converter, such as a hydraulic to mechanical rotation converter and stores the energy from an unloading core as rotational kinetic energy in a flywheel device. This stored energy can then be applied back through the hydro-mechanical converter to energise a loading core. The energy in the flywheel is proportional to speed squared. It is possible to get a large torque down to zero speed, where the torque is converted to pressure by the hydro-mechanical converter and then to a force by the hydraulic cylinder on the core. Thus the maximum force that can be applied to the loading core is not limited by the amount of energy stored.

In one embodiment the power converter is configured to convert linear mechanical energy to hydraulic energy to rotary mechanical energy.

In one embodiment the power converter comprises at least one hydraulic piston connected to the core and a hydraulic pump or motor.

In one embodiment the power converter comprises at least one hydraulic piston connected to the core and a hydraulic cylinder connected to a linear-rotational converter.

In one embodiment the power converter comprises a mechanical-hydro-mechanical converter.

In one embodiment the power converter comprises a mechanical system of pulleys to convert from high force linear motion to low torque rotational motion.

In one embodiment the power converter comprises a rotating cam system to convert from linear to rotational motion.

In one embodiment the power converter comprises an electro-mechanical actuator having a motor driven ball screw rod actuator, wherein the flywheel is positioned between the motor and the ball screw rod.

In another embodiment of the invention there is provided a heat pump system comprising:
a first Shape-Memory Alloy core;
a second Shape-Memory Alloy core positioned in fluid communication with the first Shape-Memory Alloy core;
a hydro-mechanical converter connected to the first and/or second core; and
a flywheel device configured to store energy from an unloading first Shape-Memory Alloy core via the hydro-mechanical converter and provide the stored energy back to a loading second Shape-Memory Alloy core via the hydro-mechanical converter.

In one embodiment the power converter comprises a hydraulic pump/motor.

In one embodiment the power converter comprises a hydraulic cylinder connected to a linear-rotational converter.

In one embodiment the first and second cores are loaded and unloaded 180° out of phase with each other.

In one embodiment a pressure relief valve is connected to a high pressure fluid line of the first and/or second core and configured to prevent a build-up of pressure in the heat pump system.

In one embodiment a check valve is connected to the low pressure fluid line and configured to allow the hydro-mechanical converter to draw fluid from a tank.

In one embodiment an electric motor is connected to the flywheel to provide an energy input.

In one embodiment a hydraulic motor is connected to the flywheel to provide an energy input.

It will be appreciated the flywheel device provides a torque to the hydro-mechanical converter, wherein the torque is converted to a pressure which in turn is converted to a force by the hydraulic cylinder on the core and applied to the core during loading.

In one embodiment a gearbox is positioned on one side of the flywheel device and configured to optimise the speed of the flywheel and energy input devices.

In one embodiment where a third Shape-Memory Alloy core is added, a valve assembly is connected to the first, second and third Shape-Memory Alloy core. It will be appreciated that any number of Shape-Memory Alloy cores can be used.

In one embodiment the valve assembly comprises a core isolation valve configured so that more than two cores can operate.

In one embodiment the valve assembly comprises a core isolation valve configured so that the hydraulic pump/motor runs in a constant direction.

In one embodiment a control valve and a check valve are configured so that the 20 hydraulic pump/motor runs in a constant direction above zero speed.

In one embodiment the heat pump system comprises a third Shape-Memory Alloy core and a fourth Shape-Memory Alloy core.

25 In one embodiment the first, second and third Shape-Memory Alloy cores run 120 degrees out of phase with each other.

In another embodiment there is provided a method of controlling the operation of a Shape-Memory Alloy heat pump comprising the steps of:
positioning a first Shape-Memory Alloy core in fluid communication with a a second Shape-Memory Alloy core via a hydro-mechanical converter configuring a flywheel device to recover and store energy from an unloading Shape-Memory Alloy core via the hydro-mechanical converter; and
providing the stored energy to the loading Shape-Memory Alloy core via the hydro-mechanical converter.

In a further embodiment there is provided method of controlling the operation of a Shape-Memory Alloy heat pump comprising the steps of:
positioning a first Shape-Memory Alloy core with a
a second Shape-Memory Alloy core connected via a power converter;
configuring a flywheel device to recover and store energy from an unloading Shape-Memory Alloy core via the power converter; and
providing the stored energy to the loading Shape-Memory Alloy core via the power converter.

In another embodiment there is provided a Shape-Memory Alloy heat pump system comprising a first Shape-Memory Alloy core; a second Shape-Memory Alloy core positioned in fluid communication with the first Shape-Memory Alloy core; a mechanical-translational rotary converter connected to the first Shape-Memory Alloy core and the second Shape-Memory Alloy core; and a flywheel device configured to recover and store energy from an unloading first Shape-Memory Alloy core via the mechanical-translational rotary converter, for example electrically powered, and provide the stored energy back to a loading second Shape-Memory Alloy core via the mechanical-translational rotary converter. The function of the electro-mechanical mechanical-translational converter is the same as the hydro-mechanical motor as hereinbefore described with respect to the Description and Claims. An electro-mechanical converter is suitable for lower actuation forces.

In a further embodiment there is provided Shape-Memory Alloy heat pump system comprising a Shape-Memory Alloy core; a hydro-mechanical or mechanical-translational rotary converter connected to the Shape-Memory Alloy core; and a flywheel device configured to recover and store energy when unloading the Shape-Memory Alloy core via the hydro-mechanical or mechanical-translational rotary converter and provide the stored energy back to the Shape-Memory Alloy core during a loading phase via the hydro-mechanical or mechanical-translational rotary converter.

### BRIEF DESCRIPTION OF THE DRAWINGS

The invention will be more clearly understood from the following description of an embodiment thereof, given by way of example only, with reference to the accompanying drawings, in which:-

FIG. 1 is a high level system diagram of an SMA material based heat pump system;

FIG. 2 is a block diagram showing the main components to achieve work recovery for a SMA based heat pump;

FIG. 3 illustrates two SMA cores connected together using a hydraulic pump and a flywheel circuit arrangement, according to one embodiment of the invention;

FIG. 4 illustrates two SMA cores connected together via a hydraulic cylinder connected to a linear-rotational converter and a flywheel circuit arrangement, according to one embodiment of the invention;

FIGS. 5 & 6 illustrate an SMA heat pump with a plurality of SMA cores, actuated by hydraulic pistons which are then connected to a hydro-mechanical converter and a flywheel device using a control valve assembly;

FIGS. 7 & 8 illustrate an SMA heat pump with a plurality of SMA cores actuated by hydraulic pistons which are then connected to a hydro-mechanical converter and a flywheel device using a control valve and check valve assembly;

FIG. 9 illustrates three SMA cores connected together actuated by hydraulic pistons which are then using a hydraulic pump and a flywheel circuit arrangement, according to one embodiment of the invention;

FIG. 10 comprises a number of graphs illustrating various parameters of the first and second SMA core shown in FIG. 3 during operation; and

FIG. 11 comprises a number of graphs illustrating various parameters of three SMA cores shown in FIG. 9 during operation.

### DETAILED DESCRIPTION

The operation of a heat pump using SMA material is known and fully described in PCT patent publication number WO2019/149783, assigned to the assignee of the present invention, and incorporated fully herein by reference. The present invention is particularly concerned with a heat pump system having two or more connected SMA cores. In the context of the present invention it is envisaged any number of SMA cores can be employed in the SMA based heat pump, according to various embodiments of the invention.

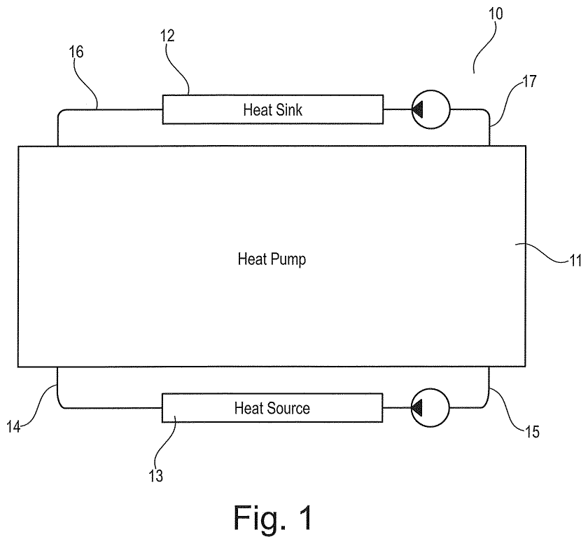

FIG. 1 is a high level system diagram of an SMA material based heat pump system indicated generally by the reference numeral 10. A housing 11 houses two or more SMA cores that are in fluid communication with a heat sink and heat source 12, 13 that can act as a heating or cooling system depending on the application required.

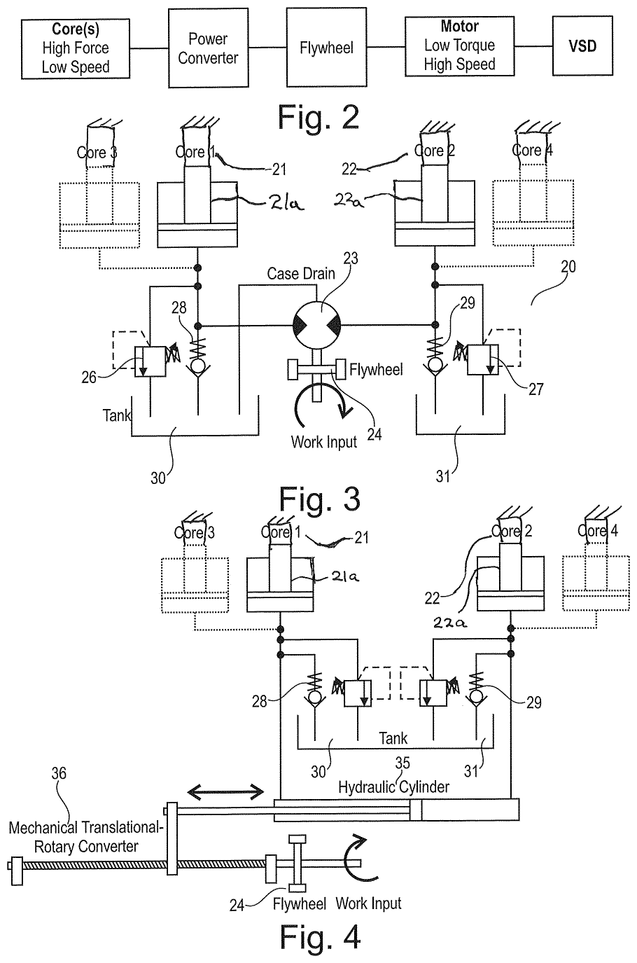

FIG. 2 is a block diagram showing the main components to achieve work recovery for a SMA based heat pump, according to the invention. A power converter is suitably connected to a first Shape-Memory Alloy core and a second Shape-Memory Alloy core. A flywheel device is configured to recover and store energy from an unloading first Shape-Memory Alloy core via the power converter and provide the stored energy back to a loading second Shape-Memory Alloy core via the power converter. The power converter can be embodied in a number of different ways, as described with reference to the accompanying description and/or figures. The power converter allows for efficient work recovery that can be applied to any concept for loading of the SMA cores that converts high force, low speed linear motion to high speed, low torque rotational motion.

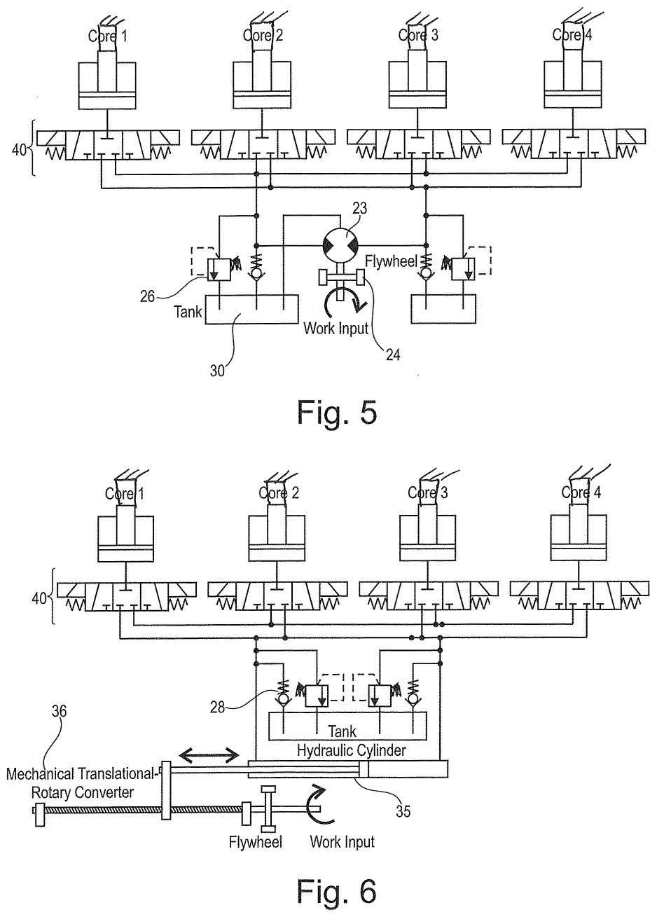

FIG. 3 illustrates a heat pump system indicated by the reference numeral 20 where two SMA cores 21, 22 are connected together using a power converter, such as a hydraulic pump circuit, 23, and a flywheel circuit 24 arrangement. The two cores 21, 22 are connected together directly through the hydraulic pump 23 with no control valves. Each SMA core 21, 22 is actuated by a hydraulic piston 21a, 22a and each piston is connected to the hydraulic pump circuit 23 to make up the power converter. The hydraulic pump circuit 23 is used to convert from the fluid domain to the rotational mechanical domain. The flywheel device 24 is situated on a pump shaft with a work input device (not shown) behind the flywheel. The work input device (not shown) can be powered by a battery or from a mains grid or other suitable power source. The flywheel device 24 stores the energy from one core as it unloads and then delivers the energy to the loading core to increase the pressure on the loading core. The work input device provides energy into the system, matching the energy lost through SMA hysteresis and system losses.

When an unload/load cycle on an SMA core is started, the pressure difference across the hydraulic pump circuit 23 is large, this causes the pump to operate as a motor, accelerating the shaft which causes the flywheel device 24 to accelerate, thus storing energy by virtue of the angular moment of the flywheel device 24. As the pressure in the two cores equalises, the acceleration of the flywheel reaches zero, the speed of rotation is at its highest and the most energy is stored in the flywheel device. The hydraulic pump/motor now acts as a pump, taking energy from the shaft to move fluid from one core to the other and produce a pressure drop across it. This causes the flywheel device 24 to slow down. The flywheel provides the energy to pump fluid into the loading core up to the required pressure at which point the shaft speed reaches zero. The operation is then reversed with the rotational speed of the flywheel device 24 also reversed.

The valveless hydraulic system, hydraulic pump/motor, flywheel device and energy input device arrangement provides an efficient way to activate or load a core as the only significant losses are the mechanical and hydraulic losses of the hydraulic pump/motor, which are typically very low. The utilisation of the flywheel to store energy during the unloading of a core and return it when a core is loading allows for much smaller physical devices as only the flywheel sees the peak torque. The energy input device such as motor and inverter can be sized and run at constant power or constant torque, meaning high utilisation of the components and a reduced size and cost. This provides excellent work recovery in the heat pump. It will be appreciated that in this embodiment no valves are required for the efficient loading of each core, while at the same time allowing efficient work recovery in the heat pump system.

Hydraulic pumps/motors can sometimes leak fluid back to tank as a loss. Thus the fluid volume in the system slowly decreases, so the check valve arrangement is required so that the pump can draw fluid back into the system from the tanks. Optionally, pressure relief valves can be included as a safety measure to ensure that the system pressure is kept below a critical level.

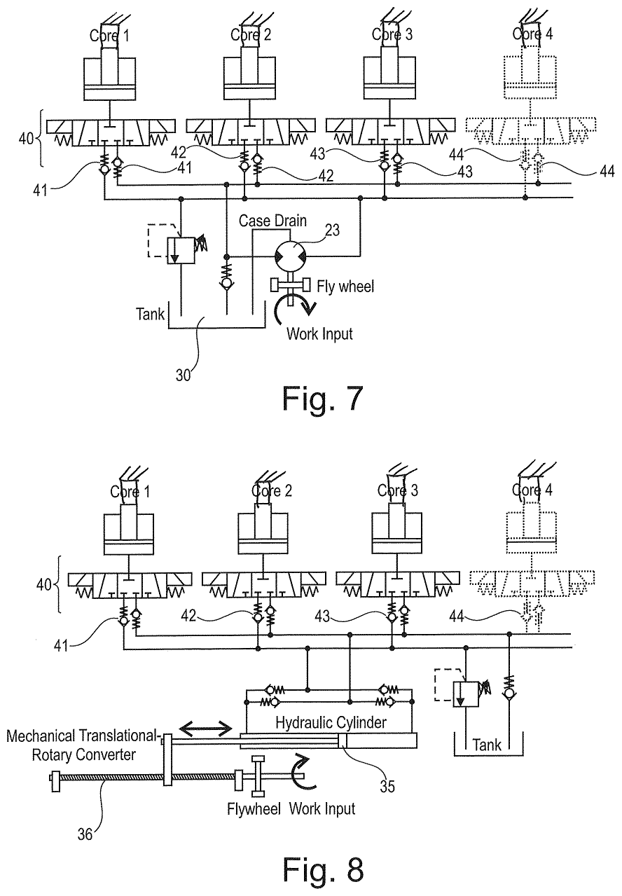

FIG. 4 illustrates two SMA cores hydraulically connected together via a hydraulic cylinder 35 connected to a linear-rotational converter 36 and a flywheel circuit arrangement 24. The operation of FIG. 4 is similar to FIG. 3 except the system uses a hydraulic cylinder and mechanical translational rotary converter 36 to convert from the fluid domain to the rotational domain. The flywheel device 24 is then attached to the rotating shaft with the work input behind it. The hydraulic cylinder 35 will have a cross-sectional area (CSA) considerably less than that of the core to reduce the force and increase the velocity of the system. The translational rotary converter introduces a further mechanical advantage, increasing the speed and decreasing the load.

An optional gearbox may be introduced on one side of the flywheel device 24 to optimise the speed further. This has the result that the size of the flywheel device 24 and or work input device can be reduced where the physical dimensions of the SMA heat pump are important.

An optional pressure relief valve 26, 27 is connected to each core 21, 22 and configured to prevent the heat pump system from being over-pressurised.

In the embodiment of FIG. 4 the hydraulic cylinder 35 has no fluid loss to tank, so there is no essential need for a check valve from the tank and the system can be operated as a closed sealed system. In the event that the pressure relief valves are included and operated, a check valve 28, 29 allows the mechanical-hydro-mechanical converter to draw fluid from a tank 30, 31 in the event there is no fluid left in the core.

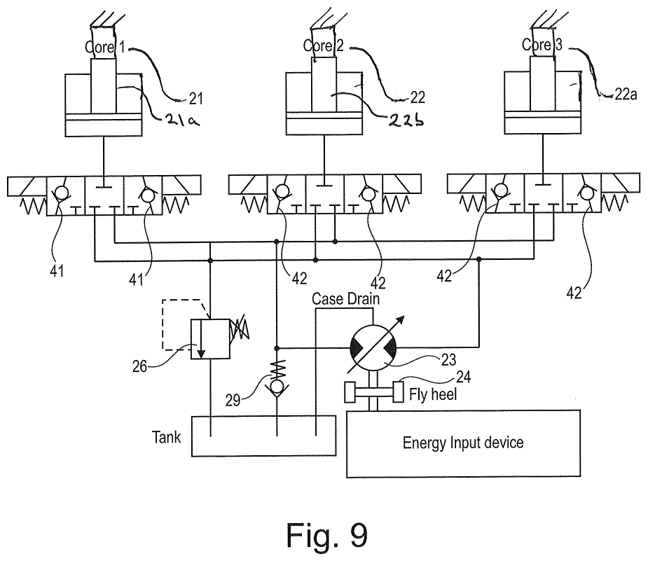

FIGS. 5 and 6 illustrate an SMA heat pump with a plurality of SMA cores connected to a mechanical-hydro-mechanical converter and a flywheel device 24 using a control valve assembly 40. The addition of the control valve assembly 40 on each core to isolate the cores enables operation using more than two cores. In the system of FIGS. 5 and 6 the heat pump system can operate a multiple of two cores. The phase angle between the cores can be set at 360°/nCores, when ‘n’ is the number of cores in the system and ‘n’ is greater than two. At any one time, one core is unloading and one core is loading, whilst the remaining cores are held either loaded or unloaded.

FIG. 5 shows a hydraulic pump/motor and a flywheel device using the control valve assembly. In this system the hydraulic pump/motor can either be run reversing or in a constant direction. However, it needs to reach zero speed at the end of each load/unload to give a period of time for the valves to change position, during which point there will be a time when no valves are open. The advantage of this system is that more than two cores can be operated with a phase difference of 360°/nCores.

FIG. 6 is similar to FIG. 5 and operates in a similar manner. The hydraulic pump/motor is replaced by a hydraulic cylinder 35 connected to a linear-rotational converter 36. The control valve assembly 40 works in the same way to isolate different SMA cores between loading and unloading where there are more than two SMA cores in the system.

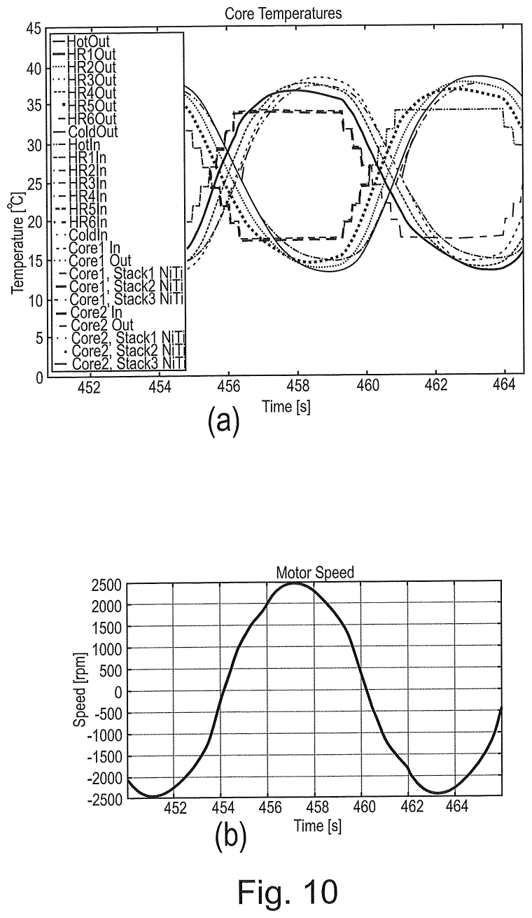

FIGS. 7 & 8 illustrate an SMA heat pump with a plurality of SMA cores connected to a mechanical-hydro-mechanical converter, a flywheel device, a check valve assembly 41, 42, 43, 44 and a control valve assembly 40. The addition of the check valve assembly allows for continuous flow at the hydraulic pump meaning the pump never has to go to zero speed. The other advantage is it allows odd numbers of cores. The check valves 41, 42, 43, 44 allow for the opening of the valve to the next core to be loaded before closing the previous core's valve, thus allowing fluid to flow through the hydraulic pump 23 and allowing the hydraulic pump to be above zero speed all of the time. Thus the system can be tuned to operate within the peak efficiency range of the hydraulic pump/motor and the electric motor.

The configuration in FIG. 8 acts similarly to the configuration in FIG. 6, except any number of cores can be operated. With FIG. 6, only an even number of cores are connected.

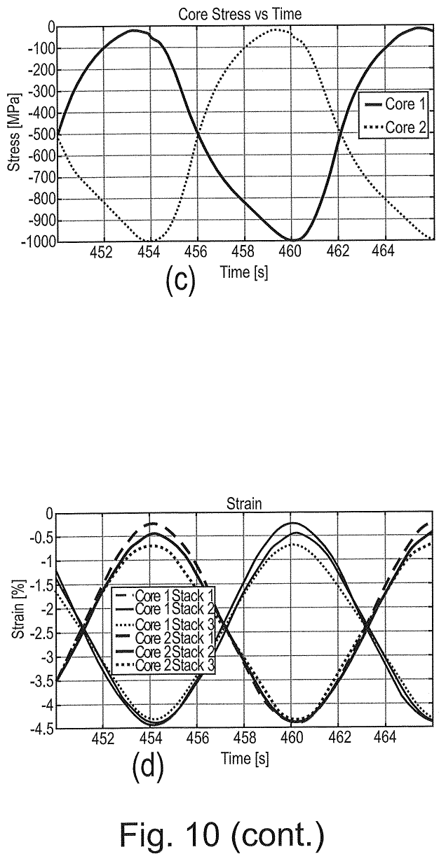

FIG. 9 illustrates three SMA cores connected together using a hydraulic pump and a flywheel circuit arrangement as per the configuration shown in FIG. 4. In the three core system shown in FIG. 9 a valve assembly 41, 42, 43 is required for each core 21, 22, 22a to connect each to either the pressure or return line of the hydraulic pump circuit 23. Suitably each core runs 120° out of phase for a three core system. The hydraulic pump circuit 23 rotates in a constant direction. A pressure relief valve 26 stops the system from being over-pressurised. A single check valve 29 allows the pump to draw from tank 30 when there is no fluid left in one of the cores.

The combination of the hydraulic system and the valves means that the pump can now be run in a constant direction. For example, the connection to the cores switching can be implemented using the following sequence:
120° high pressure side of pump
60° isolated
120° low pressure side of pump
60° isolated

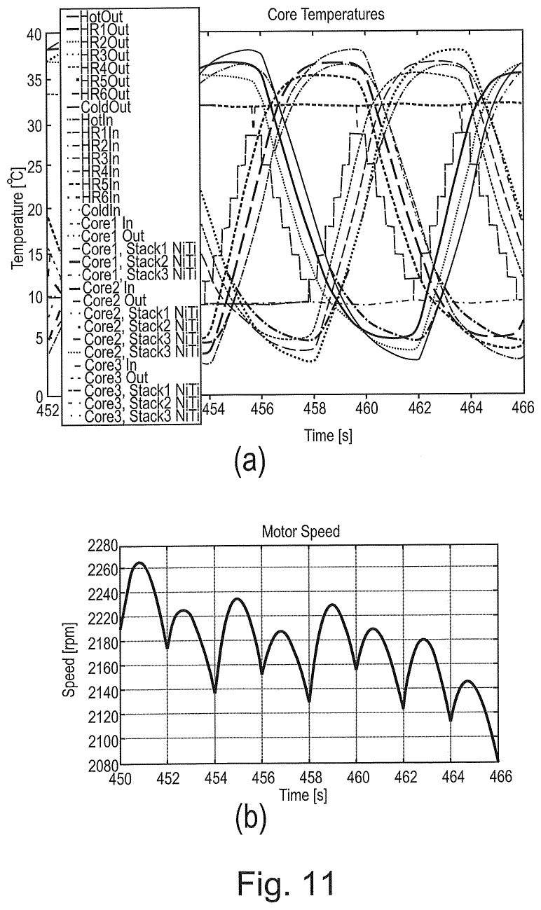

FIGS. 10a to 10d show a number of graphs illustrating various parameters of the first and second SMA core shown in FIG. 3 during operation. In these examples time 454 to 466 will be taken as one cycle.

FIG. 10a shows the fluid inlet and outlet temperatures of each core. The cores are running a 12 second cycle in this example, with the first core and second core running 6 seconds apart for phasing, or 180 degrees. During the heating phase the SMA material is being compressed and therefore heats the fluid stream and this can be seen in 9a from time 454 to 460 in core 2. During the cooling phase the load is being released from the SMA material and therefore cooling the stream, in this example from time 460 to 466 in core 2. The graph FIG. 10 (b) shows a fully reversing hydraulic pump cycle where from time 454 to 460 the hydraulic fluid from core 1 is being pumped from core 1 to core 2. Initially, the fluid pressure in core 1 is very high and the fluid pressure in core 2 very low. This large pressure delta is converted into a large torque by the hydraulic motor which increases the speed of flywheel and thus energy is put into the flywheel. At time 457s, the fluid pressure in core 1 and 2 are equal and thus no torque is produced by the hydraulic motor. This is the point of maximum speed in the cycle and thus also the point when the most energy is stored in the flywheel. From 457s to 460s the pressure in core 2 is now higher than in core 1 and so the hydraulic pump now needs to be driven to move the remaining fluid from Core 1 to core 2. The energy previously stored in the flywheel is now used to drive the pump reducing the speed until its speed reaches zero and the flywheel energy is fully depleted. At this point core 2 is then fully active and core 1 is fully unloaded. In FIG. 9b this process is then reversed from time 460 to 466, wherein the energy is transferred back to core 1 from core 2 via the flywheel and pump, but it can be seen the system runs in reverse for this to be achieved.

In an ideal system, with no losses and no hysteresis, the system can theoretically continue indefinitely without any energy input. However, as the material has hysteresis some of the energy put into the material when loaded is converted to heat and is not available as work when being unloaded. In addition, there are hydraulic losses due to friction and leakage and flywheel losses in friction and wind resistance. Energy therefore needs to be put into the system to continue operation. As long as the total energy put into the system over the course of a half cycle matches exactly the energy lost, then the system will run consistently from cycle to cycle.

FIG. 10c shows the core stress vs time for each core in this example. In this case a zero stress equates to a core being fully unloaded. A figure of 1,000 MPa in this example represents a fully loaded core. It will be appreciated that the potential range of operation is large and is not limited, for example some cores can be loaded with <200 MPa, some go to 1400 MPa.

FIG. 10d shows the core strain which of course follows the same trend as the stress and motor speed because they are inter-related.

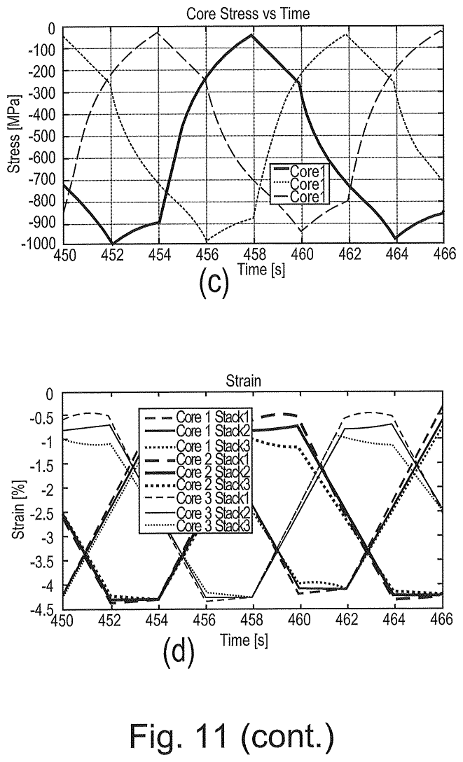

FIGS. 11(a) to (d) comprise a number of graphs illustrating various parameters of three SMA cores shown in FIG. 9 during operation. The addition of the third core to the system results in close to 100% heat exchanger utilisation and the internal fluid temperature delta decreases in the heat pump. As shown in FIG. 11a the core temperature delta is much lower despite more heat output being achieved. FIG. 11b shows the motor speed during the cycle. One can see that the speed is much more consistent than in the two core example but the pattern of acceleration and deceleration correlating to storing and rejecting energy in the flywheel is still the same. FIG. 11d shows the strain of each core. The rate of change of strain during loading and unloading is now quite constant due to the pump running at constant speed. ⅙th of the cycle is spent at constant maximum strain and ⅙th at constant minimum strain. FIG. 10c shows the stress of each core. Unlike the strain, the stress varies continuously, due to the changes in temperature.

In the context of the present invention the power converter system used to provide the load in an SMA heat pump can take many forms, for example hydraulic, electro mechanical, or any another suitable means. The end result of any of these systems is the same where each system converts very high force, low speed, linear motion of the core to high speed, low torque rotational motion with energy input by a high speed rotational device such as an electric motor.

Each SMA core loads and unloads a lot like a spring, but with hysteresis. The SMA core has inherent spring like properties due to the expansion and contraction of the SMA material between loading and unloading. Most of the energy put in to load the SMA core, is returned again when unloading of the SMA core occurs. It is desirable to have a work recovery system to efficiently recover the work during unloading, such that the network input is minimised and thus COP and EER are maximised. Effectively the SMA core connected to a flywheel device via the power converter can function as a mass-spring system. For loading an SMA core it is desirable to go from rest to full compression and back, or from rest to full extension and back.

The increased performance of the heat pump is enabled by using the SMA cores, the power converter and a flywheel device. The following examples show how the mass of each SMA core for a mass-spring system can be calculated with and without a flywheel device:

### Example 1-No Flywheel Device

Force required: 950 kN
Displacement: 18 mm
Cycle Time: 10s
Spring Constant per core: Force/Displacement=52.78 MN/m
Total Spring Constant=52.78*2=105.55MN/m
Natural Frequency=sqrt (k/m) rad/s
Mass Required: k/((2*pi( )/10)\hat{ }2)=2.67e8 kg

In order to reach a natural period of 10s, the heat pump system will need a mass of around 267kT. To put that in perspective, this is around the mass of 1340 Boeing 747's which is unviable to implement.

### Example 2—With Flywheel Device

Taking the same numbers as Example 1, it is possible to calculate the required inertia of the flywheel device using the invention.:
Assuming two cores, at 10 s cycle time and 0-18-0 mm displacement.
Assuming a motor with speed varying from-3000 rpm to +3000 rpm.

18 mm displacement over half the cycle (5 s), so average velocity is 3.6 mm/s. The oscillation is a sine wave, so the peak velocity will be 3.6*pi( )/2=5.655 mm/s.

Converting 3000 rpm to rad/s results 314.159 rad/s.

So the effective gear ratio of the loading system is 314.159/5.655e-3=55556.

For comparing mass/inertia values across a gear ratio, the gear ratio is squared, so to calculate the inertia of the flywheel required is: 1.34e8/(55556\hat{ }2)=0.08663 kg·m².

As illustrated from Example 1 a massive and completely unviable 267 kT mass compared to a small and very viable inertia of 0.08663 kg·m² is required when the heat pump uses the SMA cores, power converter and flywheel device, according to the invention.

It will be appreciated the flywheel system can work with any number of cores, or even one core if a suitable spring was utilised in place of the second core. With more cores in the system it is possible to directly transfer more of the energy from one core to the next, with the remaining energy being stored in the flywheel device.

In another embodiment a PI (D) controller is provided to control the motor torque/power based on measured peak load. If the peak load is too low, the controller increases the torque/power slightly. If the peak load is too high, the torque/power is reduced.

It will be appreciated that in the context of the present invention the use of a flywheel and a power converter for efficient and low cost work recovery can be applied to any loading concept that converts high force, low speed linear motion to high speed, low torque rotational motion. Examples of such non-limitative designs can be:
Hydraulic loading systems utilising a hydraulic motor,
Hydraulic loading systems utilising a hydraulic piston, with or without valves. Where the hydraulic piston acts to connect multiple cores together and provide a reduction in force and increase in speed. Then a linear to rotary converter (for example a ball screw) is added to convert the linear motion to rotary. At this point the flywheel can be added, or finally a gearbox is added to increase the rotational speed further, upon which the flywheel and motor are attached.
A mechanical pulley system whereby a system of pulleys and/or wires are used to both convert from linear motion to rotational motion and to provide a significant mechanical advantage.
A mechanical cam system whereby multiple cores are driven from a cam mechanism. A rotational cam can benefit from a high ratio gearbox which then has the flywheel and motor attached. A linear oscillating cam system would need a linear to rotary converter such as a ball screw followed by an optional gearbox.
Direct actuation from an electro-mechanical actuator, for example a motor driven ball screw actuator, where the flywheel is positioned between the motor and the ball screw rod. Optional gearbox is provided in addition to the ball screw to increase the speed further.
Direct actuation from an electro-mechanical actuator, for example a motor driven roller screw and rack and pinion actuator system.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A Shape-Memory Alloy heat pump system comprising
a first Shape-Memory Alloy core;
a second Shape-Memory Alloy core;
a power converter connected to the first Shape-Memory Alloy core and the second Shape-Memory Alloy core; and
a flywheel device configured to recover and store energy from an unloading first Shape-Memory Alloy core via the power converter and provide the stored energy back to a loading second Shape-Memory Alloy core via the power converter.

2. The heat pump system of claim 1 wherein the power converter is configured to convert linear mechanical energy to hydraulic energy to rotary mechanical energy.

3. The heat pump system of claim 1 wherein the power converter comprises at least one hydraulic piston connected to the core and a hydraulic pump or motor.

4. The heat pump system of claim 1 wherein the power converter comprises at least one hydraulic piston connected to the core and a hydraulic cylinder connected to a linear-rotational converter.

5. The heat pump system of claim 1 wherein the power converter comprises a mechanical-hydro-mechanical converter.

6. The heat pump system of claim 1 wherein the power converter comprises a mechanical system of pulleys to convert from high force linear motion to low torque rotational motion.

7. The heat pump system of claim 1 wherein the power converter comprises a rotating cam system to convert from linear to rotational motion.

8. The heat pump system of claim 1 wherein the power converter comprises an electro-mechanical actuator having a motor driven ball screw rod actuator, wherein the flywheel is positioned between the motor and the ball screw rod.

9. The heat pump system as claimed in any preceding claim wherein the first and second cores are loaded and unloaded 180° out of phase with respect to each other.

10. The heat pump system as claimed in any preceding claim comprising a pressure relief valve connected to a high pressure fluid line of the first and/or second core and configured to prevent a build-up of pressure in the heat pump system.

11. The heat pump system as claimed in any preceding claim comprising a check valve connected to a low pressure fluid line and configured to allow the power converter to draw fluid from a tank.

12. The heat pump system as claimed in any preceding claim comprising an electric motor connected to the flywheel to provide an energy input.

13. The heat pump system as claimed in any preceding claim comprising a hydraulic motor connected to the flywheel to provide an energy input.

14. The heat pump system as claimed in any preceding claim wherein the flywheel device provides a torque to the power converter, wherein the torque is converted to a pressure, which in turn is converted to a force by the hydraulic cylinder on the core and applied to the core during loading.

15. The heat pump system as claimed in any preceding claim comprising a gearbox positioned on one side of the flywheel device and configured to optimise the speed of the flywheel and energy input devices.

16. The heat pump system as claimed in any preceding claim comprising a valve assembly connected to each Shape-Memory Alloy core.

17. The heat pump system as claimed in claim 16 wherein the valve assembly comprises a core isolation valve configured to maintain the rotational domain to run in a constant direction and to allow any even number of cores to operate.

18. The heat pump system as claimed in claim 16 or 17 comprising a control valve and a check valve configured to maintain the rotational domain to run in a constant direction above zero speed and to allow any number of cores to operate.

19. The heat pump system of any of claims 16 to 18 where the Shape-Memory Alloy cores run out of phase with one another by 360° divided by the number of cores.

20. The heat pump system as claimed in any preceding claim comprising a third Shape-Memory Alloy core and a fourth Shape-Memory Alloy core.

21. A method of controlling the operation of a Shape-Memory Alloy heat pump comprising the steps of:
positioning a first Shape-Memory Alloy core with a a second Shape-Memory Alloy core connected via a power converter;
configuring a flywheel device to recover and store energy from an unloading Shape-Memory Alloy core via the power converter; and
providing the stored energy to the loading Shape-Memory Alloy core via the power converter.
